(19) United States
(12) Patent Application Publication
(10) Pub. No.: US 2007/0204909 A1
(43) Pub. Date: Sep. 6, 2007

(54) INFLATOR MANIFOLD

(76) Inventors: Allen Van Camp, FRUITLAND, ID (US); William L. Courtney, ELK, CA (US)

Correspondence Address: DANIEL S. POLLEY, P.A., 1215 EAST BROWARD BOULEVARD, FORT LAUDERDALE, FL, 33301, US

(21) Appl. No.: 11/460,187

(22) Filed: Jul. 26, 2006

Related U.S. Application Data
(60) Provisional application No. 60/702,923, filed on Jul. 27, 2005.

(51) Int. Cl. F16K 15/20

(52) U.S. Cl. 137/223

(57) ABSTRACT

An inflator manifold made of all sealable plastic with a screw in valve inserted therein and an outer top end sealed shut. The all plastic construction enables the manifold to be more salt water resistant over long periods of time as compared to prior manifolds. A metal sleeve, which can be secured by placing metal in the molding or by other securing methods to the stem of the manifold, can be provided to strengthen the metal to metal clip in a quick release version.

The present application claims the benefit of and priority to U.S. Application Serial No. 60/702,923, filed Jul. 27, 2005 which is incorporated by reference in its entirety.

### FIELD OF THE INVENTION

The present invention relates generally to inflator manifolds and more particularly to a unibody single mold inflator manifold used with an inflatable article.

### BACKGROUND OF THE INVENTION

Prior art manifold designs use two or more molds including a metal or copper stem and means to secure them together. Other designs chose to be backwards compatible with the size of older inflators on the market and thus also require a “D” shaped stem.

### SUMMARY OF THE INVENTION

The present invention provides an inflator manifold preferably made of all sealable plastic and having a screw-in valve inserted therein prior to sealing an outer end of the manifold through an inserted plug. The preferred all plastic construction enables the manifold to be more salt water resistant over long periods of time, as compared to prior metal or copper manifolds. A metal sleeve can be secured to the stem of the manifold by placing metal in molding or other securing method in order to increase the strength of a metal clip connection to the manifold in a quick release embodiment. The addition of a metal sleeve helps to prevent the metal clip from wearing down or otherwise harming the stem portion of the single molded plastic inflator manifold. The present invention inflator manifold offers more drowning protection to the user by allowing them more options on their inflation means, maintenance and assembly of the end product.

### BRIEF DESCRIPTION OF THE DRAWINGS

FIG. 1 is a sectional view the inflator manifold in accordance with the present invention;

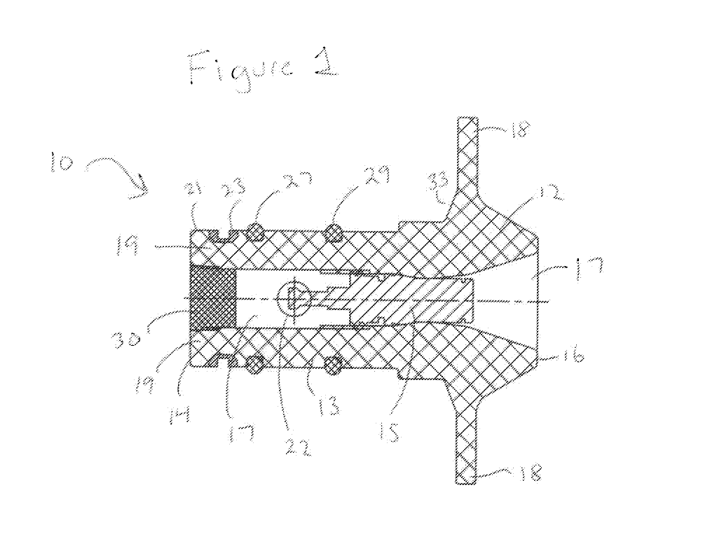

FIG. 2 is a side view of an end plug in accordance with the present invention;

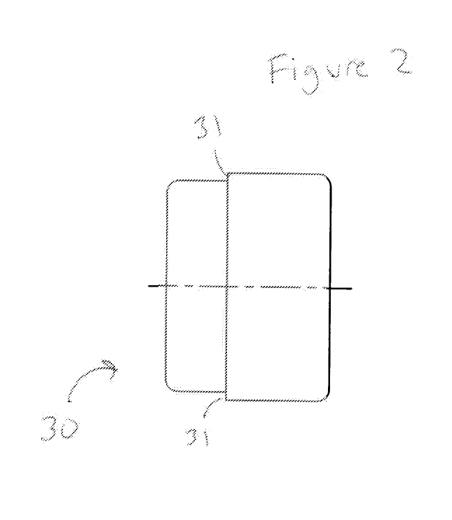

FIG. 3 constitutes several views of a clip which is removably attachachable to the inflator manifold of Figure in accordance with the present invention;

FIG. 4 constitutes several full and sectional views of the single mold body member for the inflator manifold of FIG. 1; and

FIG. 5 illustrates a sectional view showing an inflator properly secured to the inflator manifold of FIG. 1.

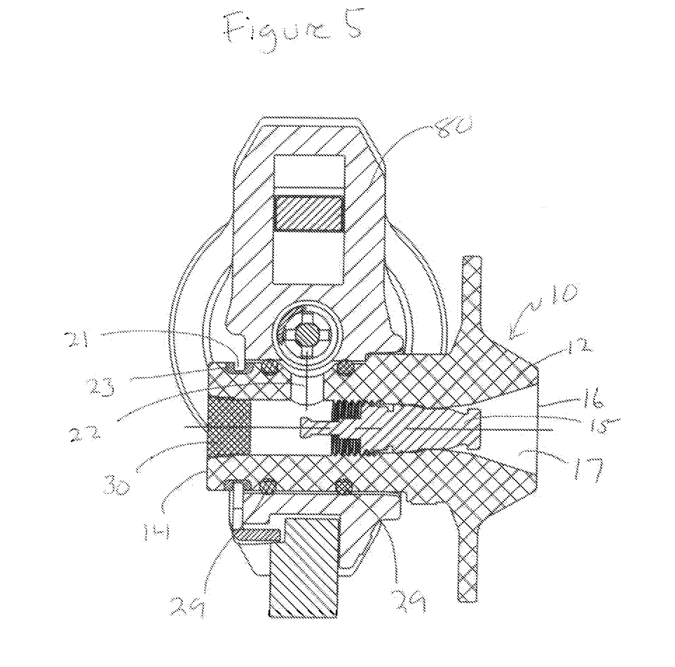

### DETAILED DESCRIPTION OF THE INVENTION

As seen in the drawings, a single mold manifold body is shown and generally designated as manifold 10. Manifold 10 includes a body member 12 having a first end 14, second end 16 and a stem portion 13. A first main passageway 17 extends through said body member 12 from first end 14 to second end 16. A gas inlet opening 22 is provided on stem portion 13 and is in communication with passageway 17. A first o-ring groove 24 and a second o-ring groove 26 are disposed on the external surface of stem portion 13, with first o-ring groove 24 disposed on one side of gas inlet opening 22 and second o-ring groove 26 is disposed on opposite side opening 22. Stem portion 13 of manifold body 12 is preferably tubular (round) or substantially tubular (round) in shape and includes a preferably annular flange 18 for welding manifold 10 to an inflatable article. A mating portion of main passageway 17 can be threaded for attachment of a valve, such as but not limited to, a standard tire core valve or other one way valve or spring loaded one way valve. By mating the threads on the valve to the inner threads of passageway 17, the valve will be properly positioned within passageway 17 of manifold body 12.

Once the valve is properly positioned within body 12, a plug 30 is disposed at first end 14 and preferably can be permanently attached and sealed at first end 14 through RF or ultrasonic sealing or other sealing techniques. Once plug 30 is sealed at first end 14, gasses entering passageway 17 through inlet opening 22 are prevented from escaping out of passageway 17 through first end 14, thus, leaving only second end 16, through the attached valve, as the travel route for the gas. As such, the gas is directed through the valve and second end 16 and ultimately into the inflatable chamber of the article attached to annular flange 18.

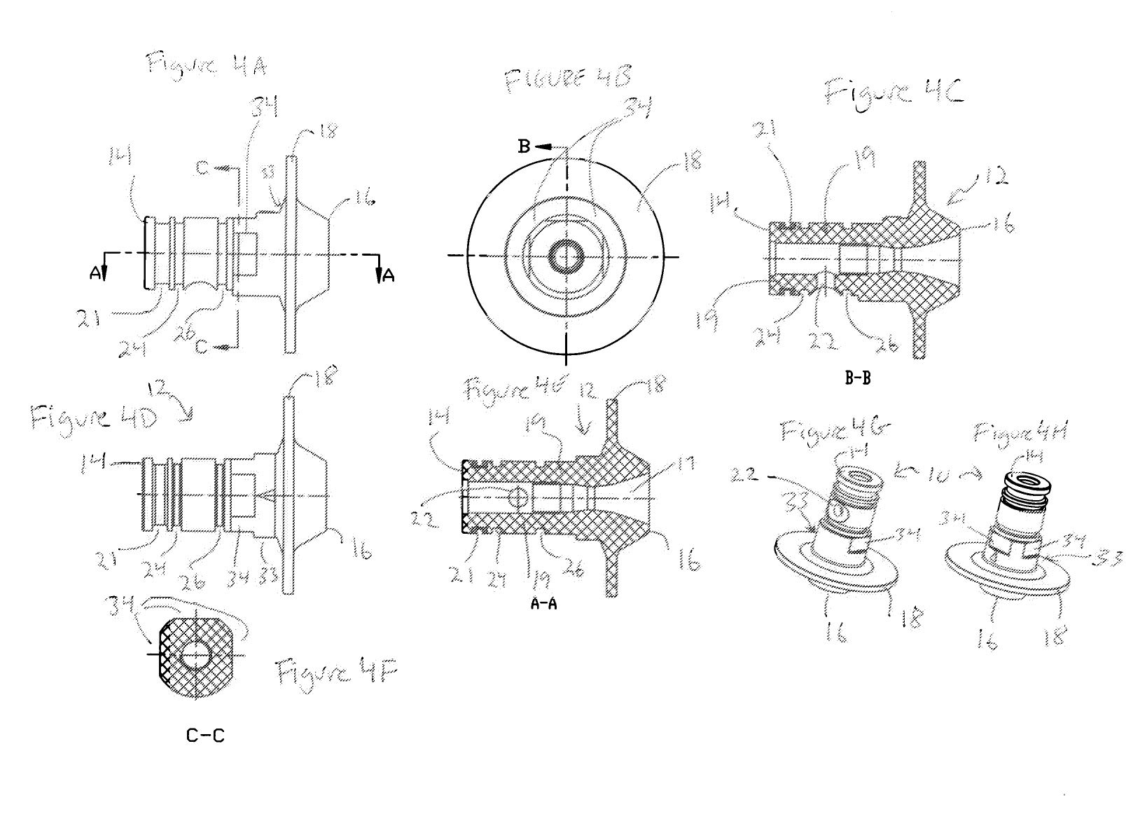

In use an inflator such as, but not limited to, a 1F or 3f C0₂ inflator is inserted over manifold body 12 and is properly aligned with respect to manifold 12 through one or more (and preferably three—though not limiting) flat or straight edges 34 which are disposed at a base area 33 of stem portion 13 (See FIG. 4f). Flat/straight edges 34 properly aligned with a corresponding configuration in the inflator, and together preferably provide only one proper mating configuration for the inflator and manifold 10 to ensure that inflator is properly aligned with opening 22 of stem portion 13 to make sure that the gas in the inflator is always properly directed into passageway 17. When properly positioned, the inflator attached to stem portion 13 terminates prior to groove 21.

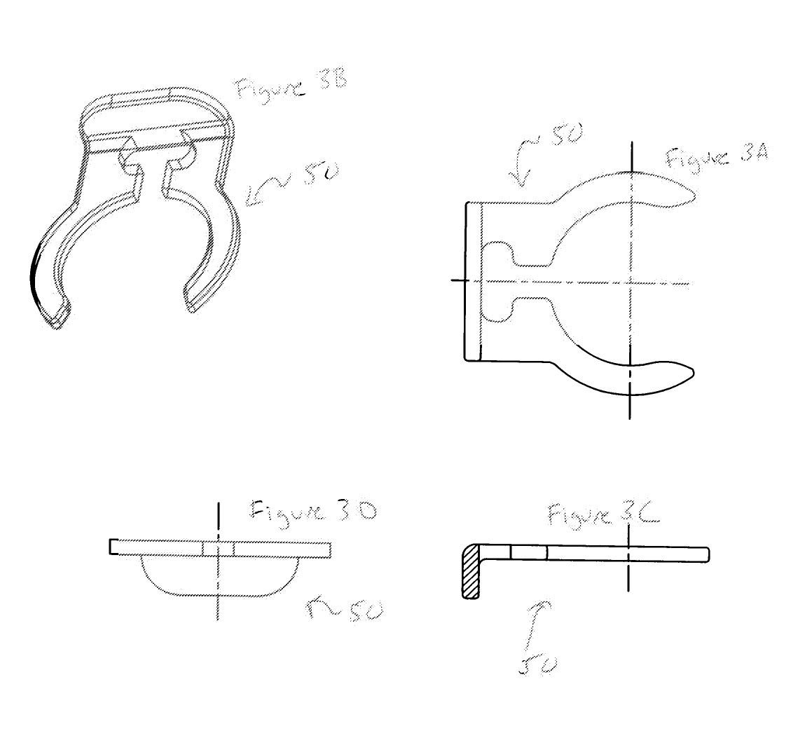

Once the proper alignment of the inflator to manifold body 12 is achieved, a substantially “C” shaped clip 50 is attached to manifold body 12 by disposing the clip 50 within groove 21 on stem portion 13 of manifold body 12 to maintain inflator in place on stem portion 13. Where clip 50 is constructed from metal, a metal sleeve, inset or insert 23 can be provided within groove 21 such that clip 50 abuts the metal sleeve, which may help reduce wear and tear on this area of stem portion 13 if metal clip 50 attached directly to plastic stem portion 13. Where clip 50 is not constructed from metal 50, the metal sleeve insert may be eliminated. Additionally, it is within the scope of the invention to also use a metal clip 50 without a metal sleeve insert. A preferred embodiment for clip 50 is shown in FIG. 3a which includes a slotted area to allow clip 50 to expand when inserted into groove 21 for securement to body member 12.

Thus, the attachment of clip 50 to stem portion 13, provides a quick release stop member to prevent the inflator from moving off of properly attached position with respect to stem portion 13. Accordingly, once clip 50 is attached to manifold body 12 and the inflator is properly aligned with the straight edges 34 of base area 33, the inflator is properly position which causes gas released from the inflator to properly enter passageway 17 through inlet opening 22. In view of end 14 being sealed through plug 30, once inside passageway 17, the released gas travels through the attached valve and out of second end 16 into the inflatable chamber of the article attached to annular flange 18.

Applicant incorporates by reference in its entirety co-pending U.S. application Ser. No. 11/421,997 filed on Jun. 2, 2006. This application shows a gas inflator 80 that can be used with the present invention manifold. However, the present invention manifold is not limited to use only with this particular gas inflator and can be used with other gas inflators and all are considered within the scope of the invention.

With the inflator properly attached, the O-rings 27 and 29 disposed within o-ring grooves 24 and 26, respectively, provide a seal (i.e. barrel seal) on both sides of inlet opening 22 between the inflator and stem portion to help prevent or reduce gas escaping from the inflator and not entering inlet opening 22. Accordingly, more of the gas within the inflator is directed through inlet opening 22 and into passageway 17.

In lieu of a substantially “C” shaped clip, other stop members can be quickly attached to the outer end 14 of stem portion 13, with or without a stem groove, to prevent the inflator from falling off from its position on stem portion and all are also considered within the scope of the invention. The stop members, including clip 50, provide for temporary or permanent attachment of the inflator to stem portion 13.

Manifold body 12 is preferably constructed from a sealable plastic material and can be molded from a single mold manifold.

Manifold 10 can be used with newly designed inflators and thus in a preferred embodiment does not have to be compatible with prior art inflators. As such, to increase the strength of plastic manifold body 12, the walls 19 of at least stem portion 13 can be thickened compared to the wall size of stem portions on metal/copper manifolds. The increase wall thickness increases the strength of stem portion 13. In a preferred embodiment, the walls are externally or outward thickened to keep the diameter of passageway 17 consistent with previous manifolds passageways, such that manifold 10 can be used with standard tire core valves and other one way valves, such as spring loaded one way valves. Though not considered limiting, in one embodiment the wall thickness of at least a portion of the manifold body member can be at least about 0.087 millimeters. However, it should be recognized that other thicknesses can be chosen and are considered within the scope of the invention.

Manifold 10 alleviates overtorqueing found with prior manifolds that cause damage to their end nuts, stem o-rings, gaskets or their plastic or metal construction.

The present invention allows for maintaining at approximately 850 to approximately 1500 psi, so that the user can safely mount and dismount without worry about damaging the life saving device.

The unibody construction of manifold 10 also allows the spread of force around infinite faces. By construction through a single mold, manifold 10 is cheaper to manufacture, which may allow an attached inflatable article, such as an inflatable PFD to increase its market share vs. similar foam products. Drowning protection for the user may also increase in view of multiple choices in inflation mechanisms and ease of replacement and maintenance.

It will be seen that the objects set forth above, and those made apparent from the foregoing description, are efficiently attained and since certain changes may be made in the above construction without departing from the scope of the invention, it is intended that all matters contained in the foregoing description shall be interpreted as illustrative and not in a limiting sense. The instant invention has been shown and described herein in what is considered to be the most practical and preferred embodiment.

What is claimed is:

1. A manifold for a gas inflator, comprising:
a single mold body member having a first end and a second end, a first internal passageway ending at the second end of said body member and a gas inlet passageway in communication with said first internal passageway, said gas inlet passageway beginning at an inlet opening on said body member, said body member having an opening at the second end for escape of gas traveling through said first internal passageway, said body member having an annular flange approximate to the second end of said body member; and
a valve disposed within said first internal passageway.

2. The manifold of claim 1 wherein said body member further comprising a first external annular groove disposed on a first side of the inlet opening and a second external annular groove disposed on a second side of the inlet opening.

3. The manifold of claim 2 further comprising a first o-ring disposed within the first external annular groove and a second o-ring disposed within the second external annular groove; wherein said first o-ring and said second o-ring aid in preventing or reducing gas leakage when transferring gas within the gas inlet passageway from a gas inflator secured to said single mold body member.

4. The manifold of claim 1 wherein said body member having an external annular retaining groove disposed between said first end and said inlet opening.

5. The manifold of claim 4 further comprising a clip member disposed within the external annular retaining groove for retaining a gas inflator secured to said single mold body member.

6. The manifold of claim 1 wherein said valve is a core valve, one-way valve or spring loaded one way valve.

7. The manifold of claim 1 wherein said first internal passageway having a series of threads for mating with a thread or threads of said valve.

8. The manifold of claim 2 wherein said body member having an external annular retaining groove disposed between said first end and said first external annular groove.

9. The manifold of claim 8 further comprising a clip member disposed within the external annular retaining groove for retaining a gas inflator secured to said single mold body member.

10. The manifold of claim 1 further comprising a plug permanently sealed at the first end of said body member.

11. The manifold of claim 4 further comprising a metal insert disposed within said external annular groove.

12. The manifold of claim 8 further comprising a metal insert disposed within said external annular groove.

13. The manifold of claim 1 wherein said body member having a specific external edge pattern near the annular flange to provide a single proper mating pattern between said body member and a gas inflator to ensure that the gas inflator is properly secured to said body member and to ensure that a gas outlet portion of the inflator is properly aligned with the inlet opening of said body member.

14. The manifold of claim 1 wherein said body member is constructed from plastic.

15. The manifold of claim 14 wherein said body member having at least a portion of its body wall thickened to at least about 0.087 millimeters.

16. A manifold for a gas inflator, comprising:
a body member having a first end and a second end, a first internal passageway ending at the second end of said body member and a gas inlet passageway in communication with said first internal passageway, said gas inlet passageway beginning at an inlet opening on said body member, said body member having an opening at the second end for escape of gas traveling through said first internal passageway, said body member having an annular flange approximate to the second end of said body member, said body member having a first external annular groove disposed on a first side of the inlet opening and a second external annular groove disposed on a second side of the inlet opening, said body member having an external annular retaining groove disposed between the first end of said body member and said first external annular groove;
a first o-ring disposed within the first external annular groove;
a second o-ring disposed within the second external annular groove;
a stop member disposed within the external annular retaining groove for retaining a gas inflator secured to said single mold body member; and
a valve disposed within said first internal passageway;
wherein said first o-ring and said second o-ring aid in preventing or reducing gas leakage when transferring gas within the gas inlet passageway from a gas inflator secured to said body member.

17. The manifold of claim 16 wherein said valve is a core valve, one-way valve or spring loaded one way valve.

18. The manifold of claim 16 wherein said first internal passageway having a series of threads for mating with a thread or threads of said valve.

19. The manifold of claim 16 further comprising a plug permanently sealed at the first end of said body member.

20. The manifold of claim 16 further comprising a metal insert disposed within said external annular groove.

21. The manifold of claim 16 wherein said body member having a specific external edge pattern near the annular flange to provide a single proper mating pattern between said body member and a gas inflator to ensure that the gas inflator is properly secured to said body member and to ensure tIat a gas outlet portion of the inflator is properly aligned with the inlet opening of said body member.

22. The manifold of claim 16 wherein said body member is constructed from plastic and having at least a portion of its body wall thickened to at least about 0.087 millimeters.

23. The manifold of claim 16 wherein the opening at said second end of said body member can taper outward.

24. The manifold of claim 20 wherein said stop member is a metal substantially C-shaped clip member.

25. A manifold for a gas inflator, comprising:
a single mold body member having a first end and a second end, a first internal passageway ending at the second end of said body member and a gas inlet passageway in communication with said first internal passageway, said gas inlet passageway beginning at an inlet opening on said body member, said body member having an opening at the second end for escape of gas traveling through said first internal passageway, said body member having an annular flange approximate to the second end of said body member, said body member having a first external annular groove disposed on a first side of the inlet opening and a second external annular groove disposed on a second side of the inlet opening, said body member having an external annular retaining groove disposed between the first end of said body member and said first external annular groove;
a first o-ring disposed within the first external annular groove;
a second o-ring disposed within the second external annular groove;
a metal insert disposed within said external annular groove. a substantially “C”-shaped clip member disposed within the external annular retaining groove for retaining a gas inflator secured to said single mold body member; and
a valve disposed within said first internal passageway, said valve selected from one of the following: a core valve, one-way valve or spring loaded one way valve;
wherein said first o-ring and said second o-ring aid in preventing or reducing gas leakage when transferring gas within the gas inlet passageway from a gas inflator secured to said body member;
wherein said body member having a specific external edge pattern near the annular flange to provide a single proper mating pattern between said body member and a gas inflator to ensure that the gas inflator is properly secured to said body member and to ensure that a gas outlet portion of the inflator is properly aligned with the inlet opening of said body member.

26. The manifold of claim 25 wherein said first internal passageway having a series of threads for mating with a thread or threads of said valve.

27. The manifold of claim 25 further comprising a plug permanently sealed at the first end of said body member.

28. The manifold of claim 25 wherein said body member is constructed from plastic and having at least a portion of its body wall thickened to at least about 0.087 millimeters.

29. The manifold of claim 25 wherein the opening at said second end of said body member can taper outward.
